(19) United States
(12) Patent Application Publication
(10) Pub. No.: US 2025/0276882 A1
(43) Pub. Date: Sep. 4, 2025

(54) SYSTEM AND PROCESS OF LIFTING VEHICLES

(71) Applicant: VEHICLE SERVICE GROUP ITALY S.R.L., Ostellato (IT)

(72) Inventors: Martina PISANO, Torino (IT); Massimo MAMBRILLA, Scalenghe (IT); Sandro RAMPONI, Porotto (IT); Antonio FALCOMATA', Torino (IT)

(73) Assignee: VEHICLE SERVICE GROUP ITALY S.R.L., Ostellato, FE (IT)

(21) Appl. No.: 19/067,165

(22) Filed: Feb. 28, 2025

(30) Foreign Application Priority Data
Mar. 1, 2024 (IT) 102024000004645

(51) Int. Cl. B66F 3/46

(52) U.S. Cl. CPC B66F 3/46

(57) ABSTRACT

Lifting systems include at least one lifting column that includes a lift configured to enable lifting of a vehicle, a control unit configured to control a height movement of the lift, a main switch switchable between a power supply position and a stop position. The system also includes a wireless communication module configured to establish wireless communication with a remote portable device, and an activator, distinct from said main switch, configured to selectively activate and deactivate the wireless communication module.

### REFERENCE TO RELATED APPLICATION

This application claims priority to Italian Patent Application IT202400004645, filed on Mar. 1, 2024, with title “Infrastruttura e Procedimento per il Sollevamento di Veicoli,” the entire content of which is hereby incorporated by reference.

### TECHNICAL FIELD

The present invention relates to a system and process for lifting vehicles, such as cars, vans, and trucks.

### BACKGROUND

Lifting systems comprising one or more lifting columns are known. Such system is used for lifting large, heavy vehicles, e.g., trucks with two, three, or more wheel axles, or when it is necessary to lift a vehicle outside the workshop.

Known lifting systems with one, two, or more columns, each independently movable within the work area, at one or more wheel axles of a vehicle. A common lifting column configuration involves four or six movable columns, wherein each column is positioned at a respective wheel.

The lifting system is configured to perform a lifting procedure that allows a vehicle to be lifted by controlling each column. To ensure the synchronisation of movements between the various movable columns, the latter may be operationally connected to each other by cable or via a wireless link, such that an operator is able to simultaneously control the various lifting columns by acting on a single column.

Lifting systems are also known to selectively control only certain lifting columns forming part of the system. For example, the movable lifting system may control the lifting columns at the front axle of the vehicle while keeping the columns at the rear axle in position stationary. In such a case, it is evident that, especially in the case of wireless connection between the various columns, it is important to correctly identify the actual position of each column forming part of the system.

A known installation procedure for movable columns involves switching on a first column, identifying it by a first code, and indicating on a control panel the actual position of the first column (e.g., indicating whether the first column has been positioned at the left front wheel). Then, the operator switches on a second column, wirelessly connects the second column to the first column identified by the first code, and arranges the second column at a different wheel (e.g., the right front wheel of the vehicle). The operator then indicates on the control panel of the second column that the latter has been positioned at the desired wheel. In this embodiment, each column requires its own control panel. Patent Application No. US 2018/354760 A1 and Patent Application No. US 2019/077644 A1 describe a further lifting system. Such system may comprise a remote portable device operable wirelessly to each of the lifting columns (e.g., performed by a common pairing procedure) to define the lifting configuration, i.e., to identify each column and to create a wireless link network between the columns to ensure synchronisation during the lifting phases. The remote portable device may comprise a control panel that provides a schematic representation of a lifting column configuration. The installation procedure involves switching on the remote device, switching on the lifting column and establishing the wireless connection between the remote device and the movable column (pairing operation): when the remote device is switched on, a light appears on the schematic representation of the remote device to indicate where to position the associated lifting column. For example, the remote device is switched on and a light appears on the schematic representation of the remote device at the left front wheel: the operator then moves the movable column to be paired with the remote device to the left front wheel of the vehicle. To associate the remote device with the lifting column, the operator is asked to enter a movable device identification code on the control panel of the lifting column. Once the first column has been configured, the operator may repeat the installation procedure for two or more further columns of the system.

Although the solutions described above are now used to lift vehicles, the Applicant noted that they are unsafe and therefore can be improved in several aspects.

### SUMMARY

In a first aspect, a lifting system (100) comprising at least one lifting column (1) is provided, said at least one lifting column (1) comprising:
a lift (2) configured to allow a vehicle (V) to be lifted;
a control unit (50) operatively connected to said lift (2) and configured to perform a lifting procedure comprising at least one step of commanding a height movement of the lift (2);
a main switch (10) which is switchable between a supply power position and a stop position, wherein in the supply power position said main switch (10) is configured to allow a power supply of said control unit (50), and wherein in the stop position said main switch (10) is configured to prevent the power supply of said control unit (50); and
a wireless communication module (11) configured to establish wireless communication with a remote portable device (30).

In a second aspect, according to the preceding aspect, the system (100) comprises an activator (12), distinct from said main switch (10), configured to selectively activate, and optionally deactivate, said wireless communication module (11). In a third aspect, according to the preceding aspect, in a first operating condition of the at least one lifting column (1), said main switch (10) is in the power supply position and said activator (12) keeps said wireless communication module deactivated. In a fourth aspect, according to the second or third aspects, said main switch (10), in a second operating condition of the at least one lifting column (1), is in the power supply position and said activator (12) activates said wireless communication module (11) to allow wireless communication to be established with said remote portable device (30). In a fifth aspect, according to any one of the preceding aspects from second to fourth, said activator (12) is configured to keep said wireless communication module (11) deactivated during the lifting procedure. In a sixth aspect, according to any one of the preceding aspects from second to fifth, said control unit (50) is operatively connected to said activator and configured to keep said wireless communication module (11) deactivated during the lifting procedure. In a seventh aspect according to any one of the preceding aspects from second to sixth, the control unit (50) is operatively connected to said activator (12) and configured, during the lifting procedure, to keep the wireless communication module (11) deactivated both in the presence and in the absence of an activation signal received from the activator (12).

In an eighth aspect, according to any one of the preceding aspects from second to seventh, the control unit (50) is operatively connected to said activator (12) and configured, during the lifting procedure, to:
receive an activation signal from the activator (12) for the wireless communication module (11);
if this activation signal is received by the control unit (50), keep the wireless communication module (11) deactivated; and
optionally, if said activation signal is not received by the control unit (50), keep the wireless communication module (11) deactivated.

In a ninth aspect, according to any one of aspects second to eighth, said wireless communication module (11) is configured to establish said wireless communication with the remote portable device (30) only after:
said activator (12) has activated said wireless communication module (11); or
only after said activator (12) has sent an activation signal to the control unit (50), said control unit being configured to activate said wireless communication module (11) downstream of the reception of said activation signal.

In a 10th aspect, according to any one of aspects second to ninth, said activator (12) comprises a proximity communication device (13) configured to establish wireless proximity communication with said remote portable device (30) when said remote portable device (30) is within a maximum distance from said proximity communication device (13). In an 11th aspect, according to the preceding aspect, said maximum distance is less than 30 cm, optionally less than 15 cm, even more optionally less than 10 cm. In a 12th aspect, according to the 10th or 11th aspect, said maximum distance is between 1 mm and 15 cm or between 1 mm and 10 cm. In a 13th aspect, according to any one of the preceding aspects from 10th to 12th, said proximity communication device (13) is configured to command activation of said wireless communication module (11) if said wireless proximity communication has been established. In a 14th aspect, according to any one of aspects 10th to the 13th, said proximity communication device (13) is configured to command a deactivation of said wireless communication module if said wireless proximity communication has not been established. In a 15th aspect, according to any one of aspects second to 14th, said activator (12) comprises an auxiliary switch (14) manually controllable and switchable between a respective activation position and a deactivation position, wherein in the activation position said auxiliary switch (14) is configured to command activation of said wireless communication module (11). In a 16th aspect, according to the preceding aspect the auxiliary switch (14), in the deactivation position, is configured to command deactivation of said wireless communication module (11).

In a 17th aspect, according to any one of the preceding aspects in combination with the 10th aspect, said proximity communication device (13) is configured to transmit to said remote portable device (30), via said wireless proximity communication, a connection code, wherein said wireless communication module (11) and said remote portable device (30) are configured to establish said wireless connection based on said connection code. In a 18th aspect, according to the preceding aspect, said wireless connection between said wireless communication module (11) and said remote portable device (30) is interdicted in the absence of said connection code.

In a 19th aspect, according to the 17th or 18th aspect, said connection code is stored in said proximity communication device (13) or in a memory (52) of the control unit (50) of the lifting column. In a 20th aspect, according to any one of aspects 17th to 19th, said connection code is stored in said remote portable device (30).

In a 21st aspect, according to any one of the preceding aspects, said at least one lifting column comprises a group of two or three or more lifting columns (1a, 1b, 1c). In a 22nd aspect, according to any one of the preceding aspects in combination with any one of aspects 17th to 20th, said connection code is different for each lifting column (1) between said lifting columns.

In a 23rd aspect, according to any one of the preceding aspects, said control unit (50) is configured to perform a wireless connection procedure (200) between said wireless communication module (11) and said remote portable device (30). In a 24th aspect, according to the preceding aspect, said connection procedure (200) comprises a step of positioning (201) said main switch (10) in the power supply position. In a 25th aspect, according to the 23rd or 24th aspect, said connection procedure (200) comprises a step of allowing the activation (202) of said activator (12), said activator emitting an activation signal when activated. In a 26th aspect, according to the preceding aspect, the activation (202) step of said activator (12) comprises establishing said wireless proximity communication or allowing said auxiliary switch (14) to be moved to the activation position. In a 27th aspect, according to 25th or 26th, said connection procedure (200) comprises activating (203) the wireless communication module (11) in response to the emission of said activation signal of the activator (12) and optionally keeping the wireless communication module (11) deactivated in case of absence of the activation signal. In a 28th aspect, according to the preceding aspect, said connection procedure (200) comprises establishing (204) wireless communication between said remote portable device (30) and said wireless communication module (11) if said wireless communication module (11) is activated. In a 29th aspect, according to the preceding aspect, said connection procedure (200) comprises transmitting (205) a unique identification code of said at least one lifting column (1) from said at least one lifting column (1) to the remote portable device (30) via said wireless communication. In a 30th aspect, according to the preceding aspect, said unique identification code is stored in an electronic memory (52) of said lifting column (1) and is representative of an identity of said lifting column (1).

In an aspect 30A, according to any one of the preceding aspects from 23rd to 30th, the connection procedure (200) comprises a step of deactivating the wireless communication module (11), after the activation (203) step, within a predefined time interval. In an aspect 30B, according to the preceding aspect, said predefined time interval is between 30 seconds and 10 minutes, optionally between 30 seconds and 5 minutes. In an aspect 30C according to any one of aspects 30A and 30B, said time interval is calculated from the activation (203) step of the wireless communication module (11).

In a 31st aspect, according to any one of the preceding aspects, wherein said lifting column comprises at least one electronic memory (52), said electronic memory (52) comprising a unique identification code representative of an identity of said lifting column (1). In a 32nd aspect according to the preceding aspect, said control unit (50) of said lifting column is configured to command said wireless communication device (11) to transmit to said remote portable device (30), via wireless communication, said unique identification code of said lifting column.

In a 33rd aspect, according to any one of the preceding aspects, said system (100) comprises two or three or more lifting columns (1a, 1b, 1c) of said at least one lifting column (1), lifting columns (1a, 1b, 1c) having respective unique identification codes different from each other. In a 34th aspect, according to any one of the preceding aspects in combination with the aspect 23rd, said connection procedure (200) is performed for each lifting column between said lifting columns (1a, 1b, 1c).

In a 35th aspect, according to any one of the preceding aspects in combination with aspect 25th, the activation (202) step of said activator (12) is performed:
manually via the auxiliary switch (14); or
approaching the remote portable device (30) to the proximity communication device (13) within this maximum distance.

In a 36th aspect, according to any one of the preceding aspects in combination with aspect 21st, said lifting columns (1a, 1b, 1c) are independently transportable from each other within a work area and positionable around said vehicle (V). In a 37th aspect, according to any one of the preceding aspects in combination with aspect 21st, said lifting columns (1a, 1b, 1c) are distinct and physically separated from each other. In a 38th aspect, according to any one of the preceding aspects in combination with aspect 21st, each of said lifting columns (1a, 1b, 1c) carries on board a power supply battery (16) configured to electrically power at least said control unit (50) and said wireless communication module (11). In a 39th aspect, according to the preceding aspect, said power supply battery (16) is configured to electrically power said activator (12).

In an aspect 39A, according to the 38th or 39th aspect, said power supply battery (16) is configured to power said lift (2) to enable height movement of the vehicle (V). In a 40th aspect, according to any one of the preceding aspects, said system is configured to perform a procedure of generating (300) a virtual network between said lifting columns (1a, 1b, 1c). In a 41st aspect, according to any one of the preceding aspects, said control unit (50) of said lifting column (1) is configured to perform said procedure of generating (300) a virtual network. In a 42nd aspect, according to the 40th or 41st aspect, said remote portable device (30) is configured to perform said procedure of generating (300) a virtual network.

In a 43rd aspect, according to any one of the preceding aspects from 40th to 42nd, said virtual network comprises said unique identification codes of each lifting column to define a group of lifting columns (1a, 1b, 1c).

In a 44th aspect, according to any one of the preceding aspects in combination with the aspect 21st, said system is configured to allow an operator to move the lift (2) of each of said lifting columns (1a, 1b, 1c) in height by operating an individual lifting column (1) of said group of lifting columns (1a, 1b, 1c) or by operating said remote portable device (30).

In a 45th aspect, according to any one of the preceding aspects from 40th to 44th, said procedure of generating (300) of the virtual network comprises the steps of:
performing said connection procedure (200) between a first lifting column (1a) of said lifting columns and the remote portable device (30);
saving (301) said unique identification code of the first column (1a) in said remote portable device (30); and
disconnecting (302) the wireless communication between the wireless communication module (11) of the first lifting column (1a) and the remote portable device (30).

In a 46th aspect, according to any one of the preceding aspects from 40th to 45th, said procedure of generating (300) of the virtual network comprises the steps of:
performing said connection procedure (200) between a second lifting column (1b) of said lifting columns and the remote portable device (30);
saving (301) said unique identification code of the second column (1b) in said remote portable device (30);
disconnecting (302) the wireless communication between the wireless communication module (11) of the second lifting column (1b) and the remote portable device (30); and
defining said virtual network comprises the unique identification code of the first lifting column (1a) and the second lifting column (1b).

In a 47th aspect, according to any one of the preceding aspects from 40th to 46th, said procedure of generating (300) of the virtual network comprises the steps of:
allowing the activation (202) of said activator (12) of a first lifting column (1a), said activator emitting an activation signal when activated, optionally wherein the activation (202) step of said activator (12) comprises establishing said wireless proximity communication or allowing said auxiliary switch (14) to be moved to the activation position;
activating (203) the wireless communication module (11) of the first lifting column (1a) in response to the emission of said activation signal of the activator (12) of the first lifting column (1a);
establishing (204) wireless communication between said remote portable device (30) and said wireless communication module (11) of the first lifting column (1a);
transmitting (205) a unique identification code of the first lifting column (1a) from said first lifting column (1a) to the remote portable device (30) via said wireless communication, said unique identification code being stored in an electronic memory (52) of said first lifting column (1a) and being representative of an identity of said first lifting column (1a);
saving (301) said unique identification code of the first column (1a) in said remote portable device (30);
disconnecting (302) the wireless communication between the wireless communication module (11) of the first lifting column (1a) and the remote portable device (30);
allowing the activation (202) of said activator (12) of a second lifting column (1b), said activator emitting an activation signal when activated, optionally wherein the activation (202) step of said activator (12) comprises establishing said wireless proximity communication or allowing to move said auxiliary switch (14) to the activation position;
activating (203) the wireless communication module (11) of the second lifting column (1b) in response to the emission of said activation signal of the activator (12) of the second lifting column (1b);
establishing (204) wireless communication between said remote portable device (30) and said wireless communication module (11) of the second lifting column (1b);
transmitting (205) a unique identification code of said second lifting column (1b) from said second lifting column (1b) to said remote portable device (30) via said wireless communication, said unique identification code being stored in an electronic memory (52) of said second lifting column (1b) and being representative of an identity of said second lifting column (1b);
saving (301) said unique identification code of the second column (1b) in said remote portable device (30);
disconnecting (302) the wireless communication between the wireless communication module (11) of the second lifting column (1b) and the remote portable device (30); and
defining said virtual network comprises the unique identification code of the first lifting column (1a) and the second lifting column (1b).

In a 48th aspect, according to any one of the preceding aspects from 40th to 47th, said procedure of generating (300) the virtual network further comprises: performing said connection procedure (200) between a third lifting column (1c) of said lifting columns and the remote portable device (30).

In a 49th aspect, according to the preceding aspect, said procedure of generating (300) the virtual network comprises the steps of:
allowing the activation (202) of said activator (12) of a third lifting column (1c), said activator emitting an activation signal when activated, optionally wherein the activation (202) step of the activator (12) comprises establishing said wireless proximity communication or allowing to move said auxiliary switch (14) to the activation position;
activating (203) the wireless communication module (11) of the third lifting column (1c) in response to the emission of said activation signal of the activator (12) of the third lifting column (1c);
establishing (204) wireless communication between said remote portable device (30) and said wireless communication module (11) of the third lifting column (1c);
transmitting (205) a unique identification code of the third lifting column (1c) from said third lifting column (1c) to the remote portable device (30) via said wireless communication, said unique identification code being stored in an electronic memory (52) of said third lifting column (1c) and being representative of an identity of said third lifting column (1c);
saving (301) said unique identification code from the third column (1c) in said remote portable device (30);
disconnecting (302) the wireless communication between the wireless communication module (11) of the third lifting column (1c) and the remote portable device (30); and
defining the virtual network comprises the unique identification code of the first lifting column (1a), the second lifting column (1b) and the third lifting column (1c).

In a 50th aspect, according to any one of the preceding aspects from 40th to 49th, said procedure of generating (300) the virtual network comprises, after the step of disconnecting the second lifting column (1b), optionally after the step of disconnecting a last lifting column (1n), of:
reconnecting (303) the remote portable device (30) to the wireless communication module (11) of the first lifting column (1a) via the wireless connection; and
transmitting (304), via the wireless connection, from the remote portable device (30) to the control unit (50) of the first lifting column (1a), said virtual network comprises the unique lifting column identification codes (1).

In a 51st aspect, according to any one of the preceding aspects from 40th to 50th, each lifting column (1) of said virtual network comprises a radio communication device (51) operatively connected to the control unit (50) and configured to establish a wireless operating network between said lifting columns of said virtual network based on the unique identification codes of the virtual network. In a 52nd aspect according to the preceding aspect, the control unit (50) of the first lifting column (1a) is configured to control, via said wireless operating network, a height movement of the lifts (2) of each lifting column of said virtual network.

In an aspect 52A, according to the 51st or 52nd aspect, at least the control unit (50) of the first lifting column (1a) is configured to:
command a height movement of the lift (2) of said first lifting column (1a), and simultaneously; and
control, via said wireless operating network, a height movement of the lift (2) of each, or at least a selected group, of said lifting columns (1a, 1b, 1c) forming part of the virtual network.

In an aspect 52B, according to any one of the preceding aspects from the 51st to aspect 52A, said radio communication device (51) is distinct from said wireless communication module (11). In a 53rd aspect according to any one of the preceding aspects in combination with aspect 10th, said proximity communication device (13) operates at a frequency between 12 MHz and 15 MHz, optionally 13.56 MHZ. In a 54th aspect, according to any one of the preceding aspects in combination with the 10th aspect, said proximity communication device (13) uses a communication protocol of the NFC type. In a 55th aspect, according to any one of the preceding aspects, said wireless communication module (11) is configured to establish wireless communication using a radio frequency signal having a frequency between 2.3 GHZ and 2.5 GHZ, optionally substantially equal to 2.4 GHZ. In a 56th aspect, according to any one of the preceding aspects, said wireless communication module (11) comprises a Bluetooth module configured to establish said wireless communication.

In a 57th aspect, according to any one of the preceding aspects, said wireless communication between the wireless communication module and the remote portable device extends spatially to define a greater coverage in extent than an extension of coverage defined by the wireless proximity communication.

In a 58th aspect, according to the preceding aspects, the coverage extent defined by said wireless communication is at least five or eight times greater than the coverage extent defined by said wireless proximity communication. In a 59th aspect, according to any one of the preceding aspects, said wireless communication between the wireless communication module and the remote portable device is two-way communication.

In a 60th aspect, according to any one of the preceding aspects in combination with 10th, said wireless proximity communication between the proximity communication device (13) and the remote portable device (30) is one-way from the proximity communication device (13) to the remote portable device.

In a 61st aspect, according to any one of the preceding aspects from first to 59th and in combination with the 10th aspect, said wireless proximity communication device (13) and remote portable device is two-way. In a 62nd aspect, according to any one of the preceding aspects in combination with the 51st aspect, said wireless operating network is a 2.4 GHz radio frequency network.

In a 63rd aspect, according to any one of the preceding aspects, the lift (2) comprises one or more lifting arms (3) movable in height and configured to contact the vehicle (V). In a 64th aspect, according to the preceding aspect, the lift (2) comprises a lifting actuator (4) operatively connected to said one or more lifting arms (3) and configured to move said one or more lifting arms (3) in height. In a 65th aspect, according to any one of the preceding aspects, said at least one lifting column comprises a weight detector operatively connected to said control unit (50) and configured to emit a weight signal representative of a weight weighing on said lifting column, said control unit being configured to receive said weight signal and to calculate, based on said weight signal, a numerical value representative of the weight weighing on said lifting column.

In a 66th aspect, according to the preceding aspect, during the lifting procedure, the control unit (50) of each lifting column (1) is configured to:
calculate this numerical value representative of the vehicle weight weighing on each lifting column;
calculate a difference between the numerical weight values measured for each lifting column; and
if this difference in weight exceeds a predefined threshold, stop the height movement of the lift.

In a 67th aspect, according to any one of the preceding aspects, said system further comprises said remote portable device (30).

In a 68th aspect, according to the preceding aspect, said remote portable device (30) comprises a wireless communication module (31) configured to establish said wireless communication with the wireless communication module (11) of the at least one lifting column (1). In a 69th aspect, according to 67th or 68th aspect, said remote portable device (30) comprises a graphical user interface (33) comprising at least one screen (34). In a 70th aspect, according to the 68th or 69th aspect, said remote portable device (30) comprises a controller (35) operatively connected to said wireless communication module (31) and said graphical interface (33). In a 71st aspect, according to any one of the preceding aspects from 68th to 70th, said remote portable device (30) comprises a battery configured to power said wireless communication module (31), said graphical user interface (33) and said controller (35). In a 72nd aspect, according to the 70th or 71st aspect, said controller (35) of said remote portable device (30) is configured to command to the screen (34) a virtual schematic representation (36) of the group of lifting columns (1), optionally said lifting columns being part of the virtual network and/or wireless operating network.

In a 73rd aspect, according to the preceding aspect, each lifting column is identified on said virtual schematic representation based on its respective unique identification code. In a 74th aspect, according to 72nd or 73rd aspect, said virtual schematic representation (36) comprises a schematic outline of the vehicle (V), and wherein the representation of each lifting column (1) on said screen (34) is positioned corresponding to a specific region of said schematic outline of the vehicle (V), optionally corresponding to the actual position of the corresponding lifting column with respect to the vehicle (V).

In a 75th aspect, according to any one of the preceding aspects from 72nd to 74th, the controller (35) is configured to allow an operator to manually move the virtual schematic representation of a lifting column between said group of lifting columns from a first region to a second region, distinct from the first region, of the vehicle (V) schematic outline to define a new configuration of the lifting columns around the vehicle (V).

In a 76th aspect, according to the preceding aspect, the procedure of generating the virtual network comprises of:
connecting said remote portable device (30) to the wireless communication module (11) of a lifting column of said group of lifting columns, optionally to the first column (1a); and
transferring said new configuration to said lifting column.

In an aspect 76A, according to any one of the preceding aspects from 72nd to 76th, said controller (35) of the remote portable device (30) is configured to update the virtual schematic representation (36) shown on the screen (34) according to the lifting columns forming part of the virtual network.

In a 77th aspect, according to any one of the preceding aspects in combination with the 67th aspect, said remote portable device (30) comprises a proximity communication device (32) configured to establish wireless proximity communication with said proximity communication device (13) of the activator (12) of the at least one lifting column (1) when said proximity communication device (32) of the remote portable device (30) is within a maximum distance from said proximity communication device (13) of the at least one lifting column (1), optionally said maximum distance being less than 30 cm, even more optionally less 15 cm, for example between 1 mm and 15 cm. In a 78th aspect, according to any one of the preceding aspects in combination with the 67th aspect, said remote portable device (30) is configured to receive from said proximity communication device (13) of the activator (12) of the at least one lifting column (1) the unique identification code of said lifting column (1). In a 79th aspect, according to the preceding aspect, said controller (35) of the remote portable device (30) is configured to command the wireless communication module (31) of the remote portable device (30) to establish wireless communication with the wireless communication module (13) of said lifting column (1) based on said connection code.

In an 80th aspect, according to the preceding aspect, said controller (35) of the remote portable device (30) is configured to command said wireless communication module (31) of said remote portable device (30) to prevent a wireless communication with said wireless communication module (13) of said lifting column (1) in the absence of said connection code. In an 81st aspect, according to any one of the preceding aspects in combination with said 69th aspect, said screen (34) of said remote portable device (30) is a touchscreen. In an 82nd aspect, according to any one of the preceding aspects in combination with 67th aspect, said remote portable device (30) is a smartphone.

In an 83rd aspect, according to any one of the preceding aspects in combination with the 67th aspect, the remote portable device (30) is movable independently of said at least one lifting column (1), optionally being movable independently of said lifting columns (1a, 1b, 1c). In an 84th aspect, according to any one of the preceding aspects in combination with the 67th aspect the remote portable device (30) is physically separated from said at least one lifting column (1). In an 85th aspect, according to any one of the preceding aspects in combination with the 67th aspect, the remote portable device (30) is physically separated from the lifting columns (1a, 1b, 1c). In an 86th aspect, according to any one of the preceding aspects in combination with the 67th aspect, the remote portable device (30) is operatively connectable to said at least one column (1) solely via a wireless connection.

An 87th aspect, is directed to a process of lifting vehicles, said process comprising a wireless connection procedure (200) between a lifting column (1) and a remote portable device (30), said lifting column (1) comprises:
a lift (2) configured to allow a vehicle (V) to be lifted;
a control unit (50) operatively connected to said lift (2) and configured to command a height movement of the lift (2);
a main switch (10) which is switchable between a supply power position and a stop position, wherein in the supply power position said main switch (10) is configured to permit a power supply of said control unit (50), and wherein in the stop position said main switch (10) is configured to prevent the power supply of said control unit (50);
a wireless communication module (11) configured to establish wireless communication with a remote portable device (30); and
an activator (12), separate from said main switch (10), configured to selectively activate and deactivate said wireless communication module (1).
said wireless connection procedure (200) comprises at least the following steps:
positioning the main switch (201) to the power supply position;
activating (202) said activator (12), said activator emitting an activation signal when activated;
activating (203) the wireless communication module (11) in response to the emission of said activation signal of the signal (12) and optionally keep the wireless communication module (11) deactivated in the absence of said activation signal; and
if the wireless communication module (11) is activated, establishing (204) wireless communication between said remote portable device (30) and said wireless communication module (11).

In an aspect 87A, according to the preceding aspect the connection procedure (200) of the process is in accordance with any one of the aspects from 23rd to 86th. In an aspect 87B, the lifting column (1) is in accordance with any one of the preceding aspects from first to 86th.

In an 88th aspect, according to any one of the preceding three aspects, the connection procedure (200) comprises a step of transmitting (205) a unique lifting column identification code (1) from said lifting column (1) to the remote portable device (30) via said wireless communication. In an 89th aspect, according to any one of the preceding four aspects, the step of positioning (201) the main switch (10) to the power supply position is performed by an operator. In a 90th aspect, according to any one of the preceding aspects from 87th to 89th, the step of activating (202) said activator (12) comprises approaching said remote portable device (30) to a proximity communication device (13) of the activator (12) of the lifting column within a maximum distance. In a 91st aspect, according to any one of the preceding aspects, said maximum distance is less than 30 cm, optionally less than 15 cm, optionally less than 10 cm, optionally between 1 mm and 15 cm. In a 92nd aspect, according to the preceding aspects 90th and 91st, the step of approaching the remote portable device (30) closer to the proximity communication device (13) is performed by an operator. In a 93rd aspect, according to any one of the preceding aspects from 87th to 92nd, the step of activating (202) said activator (12) comprises manually operating an auxiliary switch (14) of the activator (12) of the lifting column at an activation position.

In a 94th aspect, according to the preceding aspect, the step of manually actuating said auxiliary switch (14) is performed by an operator.

In a 95th aspect, according to any one of the preceding aspects from 88th to 94th, said process of lifting vehicles comprises a procedure of generating (300) a virtual network between lifting columns (1a, 1b, 1c), said procedure of generating (300) comprising at least the steps of:
setting up two or three or more lifting columns (1a, 1b, 1c);
performing said connection procedure (200) between a first lifting column (1a) of said lifting columns and the remote portable device (30);
saving (301) said unique identification code of the first column (1a) in said remote portable device (30);
disconnecting (302) the wireless communication module (11) of the first lifting column (1a) and the remote portable device (30);
performing said connection procedure (200) between a second lifting column (1b) of said lifting columns and the remote portable device (30);
saving (301) said unique identification code from the second column (1b) in said remote portable device (30);
disconnecting (302) the wireless communication between the wireless communication module (11) of the second lifting column (1b) and the remote portable device (30); and
defining said virtual network comprising the unique identification code of the first lifting column (1a) and the second lifting column (1b).

In a 96th aspect, according to the preceding aspect, said generation procedure (300) further comprises the following steps of:
performing said connection procedure (200) between a third lifting column (1c) and the remote portable device (30);
saving (301) said unique identification code of the third column (1c) in said remote portable device (30);
disconnecting (302) the wireless communication between the wireless communication module (11) of the third lifting column (1c) and the remote portable device (30); and
defining this virtual network comprising the unique identification code of the first lifting column (1a), the second lifting column (1b) and the third lifting column (1c).

In a 97th aspect, according to any one of the preceding aspects from 87th to 94th in combination with aspect 90th, the step of approaching the remote portable device (30) closer to said proximity communication device (13) of said lifting column activator (12) within said maximum distance establishes a wireless proximity communication between said proximity communication device (13) of said lifting column and said remote portable device (30). In a 98th aspect, according to the preceding aspect, the connection procedure (200) comprises a step of transmitting a connection code via said wireless proximity communication, wherein said wireless communication module (11) and said remote portable device (30) establish said wireless connection with each other based on said connection code.

In a 99th aspect, according to any one of the preceding aspects from 87th to 96th, wherein said lifting process comprises a step of generating on a screen (34) of the remote portable device (30) a virtual schematic representation (36) of the group of lifting columns (1), optionally said lifting columns being part of the virtual network and/or the wireless operating network.

In a 100th aspect, according to the preceding aspect, each lifting column is identified on said virtual schematic representation based on its respective unique identification code. In a 101st aspect, according to the 99th or 100th aspect, said virtual schematic representation (36) comprises a schematic outline of the vehicle (V), and wherein the representation of each lifting column (1) on said screen (34) is positioned corresponding to a specific region of said schematic outline of the vehicle (V) optionally corresponding to the actual position of the corresponding lifting column with respect to the vehicle (V).

In a 102nd aspect, according to any one of the preceding aspects from 99th to 101th, said lifting process comprises a step of manually moving, by the operator, the virtual schematic representation of a lifting column between said group of lifting columns from a first region to a second region, distinct from the first region, of the vehicle (V) schematic outline to define a new configuration of the lifting columns around the vehicle (V).

In a 103rd aspect, according to the preceding aspect, the procedure of generating the virtual network comprises the steps of:
connecting said remote portable device (30) to the wireless communication module (11) of a lifting column of said group of lifting columns, optionally to the first lifting column (1a); and
transferring said new configuration to said lifting column, optionally to the first lifting column (1a).

### BRIEF DESCRIPTION OF THE DESIGNS

Certain forms of construction and aspects of the invention will be described below with reference to the accompanying drawings, which are provided for illustrative purposes only and are therefore not limiting wherein:

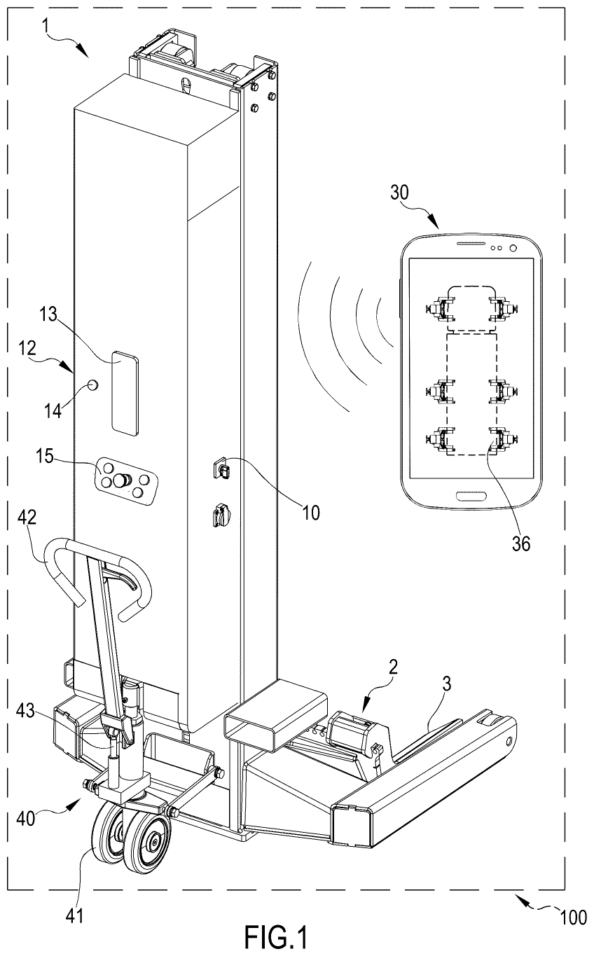

FIG. 1 is a perspective view of a system comprising a lifting column and a remote portable device;

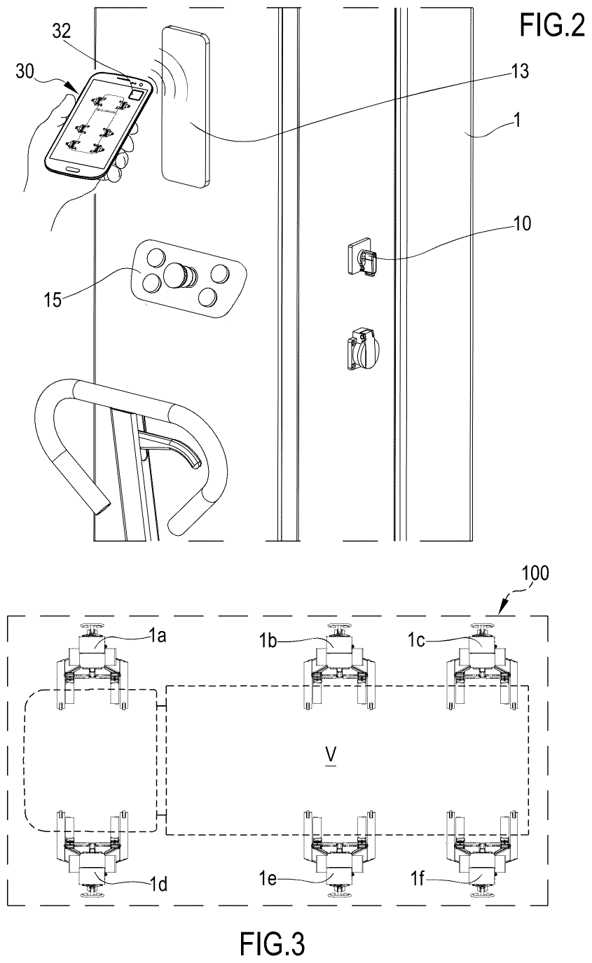

FIG. 2 shows the remote portable device in a proximity position to the lifting column proximity communication device to establish wireless proximity communication;

FIG. 3 is a schematic top view of a system comprising a plurality of lifting columns arranged around the vehicle;

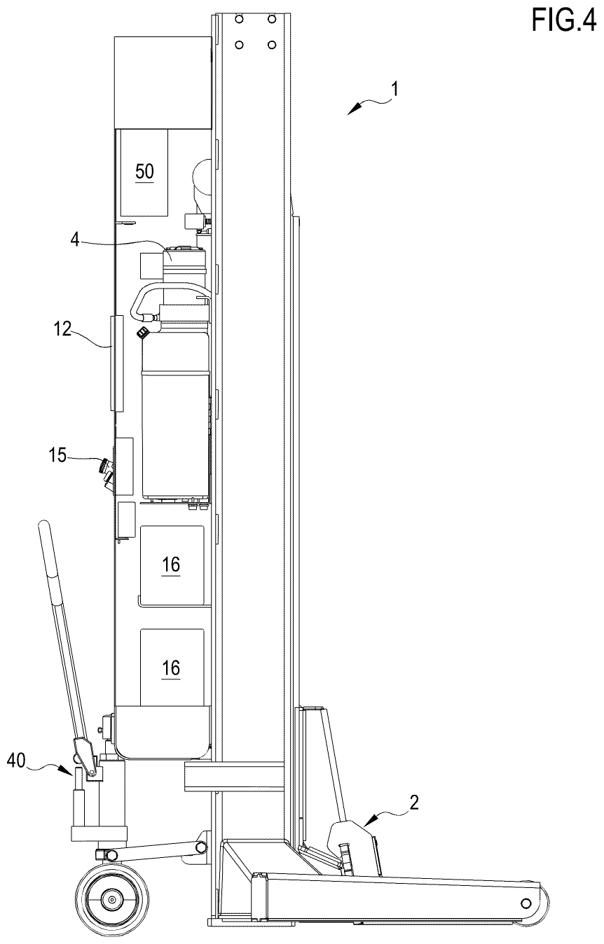

FIG. 4 is a partially cross-sectional side view of the lifting column;

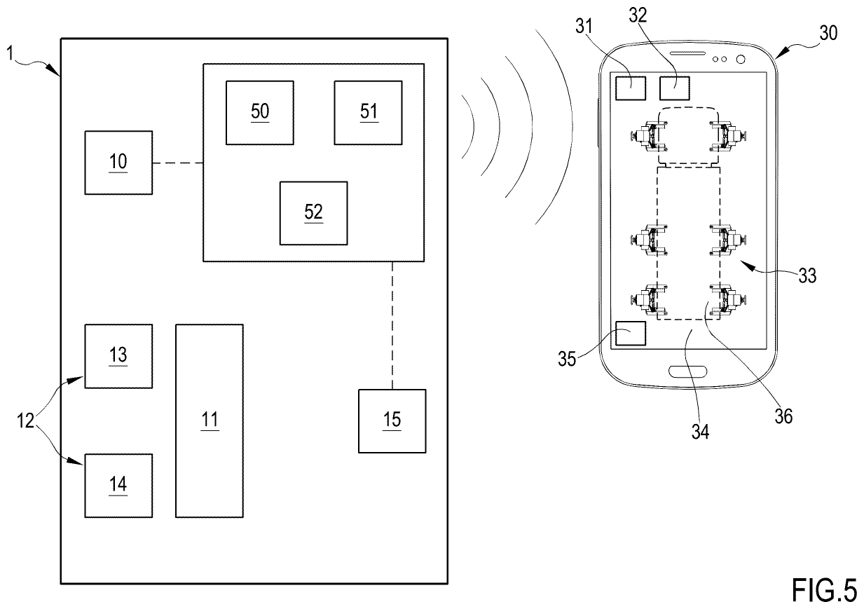

FIG. 5 is a schematic view of the main electronic components of the lifting column and the remote portable device; and

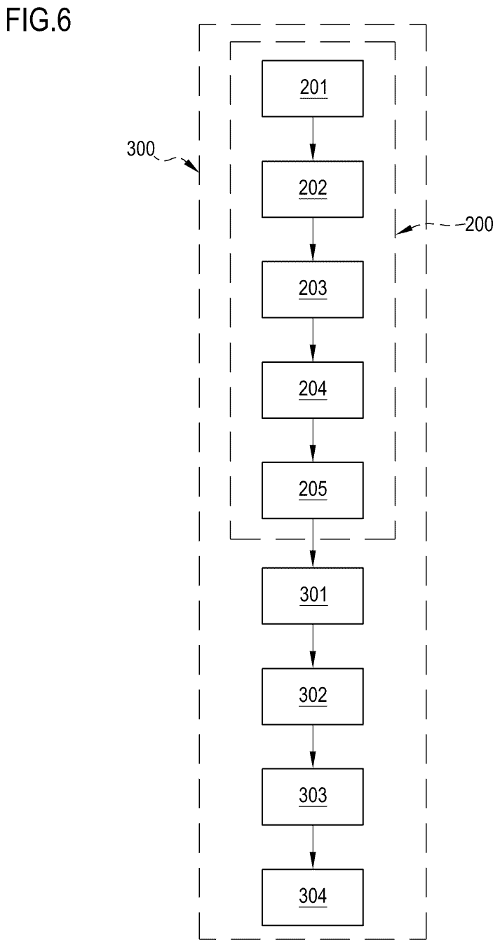

FIG. 6 shows a flow chart comprising steps of the connection procedure and the procedure of generating a virtual network.

### DEFINITIONS AND CONVENTIONS

It should be noted that in the present detailed description corresponding parts illustrated in the various figures are indicated by the same numerical references. The figures may illustrate the subject matter of the invention by means of non-scaled representations; therefore, parts and components illustrated in the figures relating to the subject matter of the invention may relate only to schematic representations.

The lifting column and/or the system described and claimed herein may comprise at least one control unit 50 configured to control operating conditions of the same. Similarly, the remote portable device 30 may also comprise a respective control unit, i.e., the controller 35, configured to control operating conditions of the remote portable device itself and/or of at least one of the columns and the system.

Control unit 50 and controller 35 may be a single unit or consist of several separate control units depending on design choices and operational requirements.

The term control unit or controller refers to a component of an electronic type, which may comprise at least one of: a digital processor (CPU), an analogue-type circuit, or a combination of one or more digital processors with one or more analogue type circuits. The control unit or controller may be “configured” or “programmed” to perform certain steps: this may be achieved in practice by any means that allows the control unit to be configured or programmed. For example, in the case of a control unit or controller comprising one or more CPUs and one or more memories, one or more programs may be stored in appropriate memory banks attached to the CPU(s); the program(s) contain instructions which, when executed by the CPU(s), program or configure the control unit or controller to perform the operations described in relation to the control unit. Alternatively, if the control unit or controller is or comprises analogue type circuitry, then the circuitry of the control unit or controller may be designed to include circuitry configured, in use, to process electrical signals in such a way as to perform the steps related to the control unit or controller.

At least part of the operation of the system may be performed by a data processing unit, or control unit or controller, which is technically replaceable by one or more computers designed to execute a portion of a software programme or firmware loaded onto a storage medium. Such a software programme may be written in any known programming language.

The data processing unit, or control unit, may be a general-purpose processor configured to perform one or more steps of the operating procedure identified in this disclosure through the software or firmware programme, or be an ASIC or dedicated processor or FPGA, specifically programmed to perform at least part of the operations of the operating procedure.

The memory medium may be non-transitory and may be internal or external to the processor, or control unit, or data processing unit. The memory medium may also be physically divided into several portions.

The term actuator refers to any device suitable for moving a body, e.g., upon command from the control unit (reception by the actuator of a command sent by the control unit). The actuator may be of an electric, pneumatic, mechanical (e.g., spring), hydraulic or other type, e.g., it may comprise a hydraulic or pneumatic cylinder or an electric motor.

### DETAILED DESCRIPTION

### System 100

Reference number 100 indicates a system for lifting vehicles, e.g., cars for transporting people or goods, vans, trucks and lorries.

The system 100 comprises at least one lifting column 1 configured to lift a vehicle, so as to allow an operator to operate underneath the vehicle. In detail, the system 100 may comprise one and only one lifting column 1, or may comprise two, three or more lifting columns 1a, 1b, 1c to define a group of lifting columns. Each lifting column 1 may be configured to lift a maximum weight of up to 10 tonnes.

Lifting columns may be movable, i.e., they may be moved by an operator within a working area, one independently of the other. In fact, lifting columns are separate and physically separated from each other: this feature allows an operator to position each lifting column in a desired position around the vehicle, e.g., at a respective wheel of the vehicle or at a lifting point.

The lifting column may comprise handling equipment 41, e.g., wheels or tracks, configured to move the column in the work area. For example, the lifting column may comprise at least three wheels to ensure the stability of the column during movement (FIGS. 1 and 4).

The lifting column may further comprise a movement mechanism 40 configured to selectively allow and prevent movement of the lifting column in the work area. The movement mechanism 40 is movable between a first position that allows the handling means 41 to move the lifting column, and a second position that prevent the handling means 41 from moving the lifting column into the work area. In the second position, the movement mechanism 40 may be configured to raise at least one wheel of the lifting column, such that a bottom portion of the lifting column contacts the ground directly: in the second position, therefore, the handling means 41 are not able to move the column. Conversely, when the movement mechanism is in the first position, the handling means 41 support the weight of the lifting column, allowing it to be moved into the work area. Note that, during a vehicle lifting procedure, the operator is required to place the movement mechanism 40 in the second position.

The movement mechanism may comprise an actuating lever 42, shown in FIG. 1, acting on an actuator 43, which is configured to switch the movement mechanism 40 between the first and second position.

The movement mechanism 40 may further comprise a towing motor operatively connected to the handling means 41 and configured to drive the handling means 41 to cause a lifting column movement or at least contribute to a lifting column movement. Wherein the movement mechanism 40 comprises said towing motor, the handling means 41 comprises at least one drive wheel or track operatively connected to the towing motor. The activation of the drive motor may be determined by movement of the drive lever 42 by an operator.

Lifting column 1 comprises a lift 2, shown in FIGS. 1 and 4, configured to lift the vehicle V. The lift 2 may be configured to lift the vehicle to a maximum height above the ground of between 1 metre and 2 metres. In detail, the lift 2 may comprise one or more lifting arms 3 movable in height and configured to contact the vehicle V to allow it to be moved at height. In the embodiment shown in the attached figures, the lift 2 comprises a first lifting arm and a second lifting arm each extended along a main extension direction. An operator, during a positioning phase of the lifting column, positions the lifting column to the side of the vehicle, and arranges the first and second arms around a wheel of the vehicle. To adapt to different wheel diameters, the first and second arms may be adjustable to vary the distance between them. Note that the lift 2, and in particular the lifting arms, may be made of metal material, such as steel.

The lift 2 may further comprise a lifting actuator 4 (FIG. 4) operatively connected to the lifting arms 3 and configured to move said lifting arms 3 in height. In one embodiment, the lift may be of an electric type; in such a configuration, the actuator 4 may also be of an electric type, for example it may comprise at least one motor. The lift may thus comprise a transmission system that connects the electric motor of the actuator 4 to the lifting arms to allow for height movement. Alternatively, the lift 2 may comprise a handling system comprising a hydraulic actuator and a hydraulic pump connected to an electric motor: the motor is then configured to drive the hydraulic pump, which is responsible for sending pressurised oil to the hydraulic actuator to determine the height movement of the lifting arms.

The lifting column 1 comprises a control unit 50 configured to control a plurality of operations, including the height movement of the lift 2. The control unit 50 is operatively connected to the lift 2 and configured to perform a lifting procedure comprising at least one step of controlling a height movement of the lift 2. The lifting procedure may thus comprise lifting and a subsequent lowering of the vehicle.

Each lifting column 1 may comprise a main switch 10 switchable between a power supply position and a stop position: in the power supply position the main switch 10 is configured to allow a power supply to the control unit 50, while in the stop position the main switch 10 is configured to prevent the power supply to the control unit 50. The main switch 10 is manually operated switch, and therefore manually operable by an operator. The main switch 10 may be located on a side panel of the lifting column so as to be easily reached and operated by an operator. In one embodiment, the main switch 10 is a bipolar type, i.e., it is designed to act on both the positive and negative poles of the lifting column's electrical circuit. Alternatively, in the case of alternating current, the bipolar main switch 10 may be pre-positioned to act on both the phase and neutral of the lifting column electrical circuit. When the lifting column 1 is not in use, the operator may switch the main switch 10 to the deactivation position in order to de-energise the electrical components of the lifting column and, consequently, to preserve the life of a power supply battery 16 of the column.

The lifting column 1 may further comprise a control panel 15, operatively connected to the control unit 50, and configured to allow an operator to move the lifting arms 3 upwards. The control panel 15 (FIG. 1) may comprise a first button configured to move the lifting arms 3 upwardly so as to determine the lifting of the vehicle. Additionally, the control panel 15 may comprise a second button configured to move the lifting arms 3 downwards so as to cause the vehicle to be lowered towards the ground. The operator is then able to control the lifting and lowering of the vehicle by acting on the control panel 15.

The control panel is operational, and therefore operable by an operator, when main switch 10 is in the power supply position. Conversely, when main switch 10 is in the stop position, the control panel is turned off, and therefore not operable by an operator.

Each lifting column 1 further comprises a wireless communication module 11 configured to establish wireless communication with a remote portable device 30. The wireless communication module 11 may also be operatively connected to the control unit 50, which is configured to control its activation and deactivation. The wireless communication module 11 is configured to establish wireless communication using a radio frequency signal, for example at a frequency between 2.3 GHZ and 2.5 GHZ, optionally substantially 2.4 GHz. The wireless communication established by the wireless communication module may cover up to 50 metres: optionally, the wireless communication established by the wireless communication module may cover a maximum distance of up to 15 metres or 10 metres.

The wireless communication module 11 may be configured to establish a two-way wireless communication with the remote portable device 30: a two-way wireless communication enables data transmission both from the wireless communication module 11 to the remote portable device 30 and from the remote portable device 30 to the wireless communication module 11.

Note that the wireless communication module 11 and the remote portable device 30 may be configured to establish wireless communication with each other based on a connection code. In the absence of such a connection code, the wireless communication module 11 and/or the remote portable device 30 may be configured to deny wireless communication.

In one embodiment, the wireless communication module 11 may comprise a Bluetooth module configured to establish said wireless communication. The wireless communication established between the wireless communication module 11 and the remote portable device 30 may therefore be a wireless communication based on a Bluetooth protocol.

The lifting column 1 may further comprise an activator 12, distinct from the main switch 10, configured to activate the wireless communication module 11. In more detail, in a first operating condition of the lifting column 1, the main switch 10 may be positioned in the power supply position, and at the same time the activator 12 keeps the wireless communication module deactivated. In a second operating condition of the lifting column 1, the main switch 10 may be positioned in the power supply position, and at the same time the activator 12 activates the wireless communication module 11 to allow wireless communication to be established with the remote portable device 30. In other words, while keeping the main switch 10 in the power supply position, the activator 12 is able to activate and deactivate the wireless communication module 11. Optionally, the activator 12 is able to electrically power and electrically de-energize the wireless communication module 11 while keeping the main switch 10 in the power supply position. The activator 12 is thus configured to make the power supply and/or activation of the wireless communication module 11 independent of the position of the main switch.

Thus, the wireless communication module 11 may be configured to establish wireless communication with the remote portable device 30 only after the activator 12 has activated the wireless communication module 11. Alternatively, the wireless communication module 11 may be configured to establish wireless communication with the remote portable device 30 only after the activator 12 has sent an activation signal to the control unit 50, wherein the control unit is in turn configured to activate the wireless communication module 11 downstream of receiving the activation signal.

In one embodiment, the activator 12 is configured to keep the wireless communication module 11 deactivated during the lifting procedure. In other words, during the height movement of the lift 2, the activator 12 is configured to keep the wireless communication module 11 deactivated. In one embodiment the activator 12 is operatively connected to the control unit 50, which is configured to keep the wireless communication module 11 deactivated during the lifting procedure. In particular, the control unit 50 operatively connected to the activator 12 may be configured, during the lifting procedure, to keep the wireless communication module 11 deactivated both in the presence and in the absence of an activation signal received from the activator 12.

In one embodiment, the activator 12 comprises a proximity communication device 13 configured to establish wireless proximity communication with the remote portable device 30 when the remote portable device 30 is within a maximum distance from the proximity communication device 13. Such maximum distance may be less than 30 cm, optionally less than 15 cm. In detail, the maximum distance may be less than 10 cm and optionally between 1 mm and 10 cm. The proximity communication device 13 may be operatively connected to the control unit 50, which in turn is operatively connected to the wireless communication module 11. In this case, the control unit 50 is configured to command activation of the wireless communication module 11 only if wireless proximity communication has been established between the remote portable device 30 and the proximity communication device 13. In greater detail, the control unit 50 may be configured to receive an activation signal representative of the fact that wireless proximity communication has been established between the remote portable device 30 and the proximity communication device 13 of the lifting column: downstream of the receipt of said activation signal, the control unit 50 is then configured to command the activation of the wireless communication module 11.

In a further embodiment, the proximity communication device 13 may be connected directly to the wireless communication module 11: in such a case, the proximity communication device 13 may be configured to command activation of the wireless communication module 11 if wireless proximity communication has been established between the remote portable device 30 and the proximity communication device 13. Note that the proximity communication device 13, or the control unit 50, may be configured to prevent activation of the wireless communication module 11 if wireless proximity communication has not been established.

The wireless communication between the wireless communication module 11 and the remote portable device 30 extends spatially to define a greater coverage in extent than the coverage extent defined by the wireless proximity communication. In greater detail, the extent of coverage defined by the wireless communication is at least three times greater than the extent of coverage defined by the wireless proximity communication. In particular, the coverage extent defined by the wireless communication is greater by at least a factor of between five and eight times than the coverage extent defined by the wireless proximity communication. The term coverage extent means the maximum distance, between lifting column and remote portable device, within which wireless communication and wireless proximity communication can be established.

In one embodiment, the wireless proximity communication between the proximity communication device 13 and the remote portable device 30 is one-way, such wherein data may only be transmitted from the proximity communication device 13 to the remote portable device 30 or vice versa. However, an embodiment may be contemplated wherein the wireless proximity communication device 13 and the remote portable device 30 is bi-directional, such wherein data may be exchanged from the proximity communication device 13 to the remote portable device 30 and vice versa.

The proximity communication device 13 may operate at a frequency between 12 MHz and 15 MHZ, optionally 13.56 MHz, to generate wireless proximity communication. In a specific embodiment, the proximity communication device 13 may use a near-field communication (NFC) protocol to establish wireless proximity communication.

The use of the proximity communication device 13 also allows a connection code required to establish wireless communication between the lifting column wireless communication module 11 and the remote portable device 30 to be transmitted to the remote portable device 30 via wireless proximity communication. The wireless communication module 11 and the remote portable device 30 are then configured to establish the wireless connection based on said connection code. The wireless connection between the wireless communication module 11 and the remote portable device 30 may be prevented in the absence of said connection code. The connection code may be stored in the proximity communication device 13 or in a memory 52 of the control unit 50. Alternatively, the connection code may be stored in the remote portable device 30. It should be noted that the connection code may comprise a network address arranged to allow mutual recognition between the wireless communication module 11 and the remote portable device 30.

Alternatively, or in combination with the proximity communication device 13 of the lifting column, the lifting column may comprise a manually controllable auxiliary switch 14 switchable between a respective activation position and a deactivation position: in the activation position, the auxiliary switch 14 is configured to control activation of the wireless communication module 11. In contrast, when the auxiliary switch 14 is positioned in the deactivation position, the auxiliary switch 14 may be configured to prevent activation of the wireless communication module 11. The auxiliary switch 14 may be a physical switch that can be manually controlled by an operator. The auxiliary switch 14 may be positioned on a side panel of the lifting column so as to be easily reached and operated by an operator.

Each lifting column 1 may further comprise an electronic memory 52 operatively connected to the control unit 50. The electronic memory 52 may comprise a unique identification code representative of the identity of the lifting column. The unique identification code may comprise a numeric, alphabetic or alphanumeric code. It should be noted that the lifting columns 1a, 1b, 1c have different respective unique identification codes. In other words, each lifting column comprises its own unique identification code different from the other lifting columns.

When a wireless communication is established between the remote portable device 30 and the wireless communication module 11 of a lifting column 1, the control unit 50 of said lifting column may be configured to command the wireless communication module 11 to transmit to the remote portable device 30 the unique identification code of the lifting column 1 via said wireless communication. The procedure of generating a virtual network designed to connect the various lifting columns together is described in greater detail later in the specific section.

As previously discussed, the system 100 may comprise two or three or more lifting columns 1a, 1b, 1c. Each of these lifting columns may be moved within the work area and positioned close to the vehicle, for example at the wheels of the vehicle, so as to allow the lifting arms to engage the vehicle, as shown schematically in FIG. 3. For example, the system in FIG. 3 shows a 3-axle vehicle and six lifting columns 1a-1f, each positioned at each wheel of the vehicle. To lift the vehicle in a balanced manner, and taking into account that the lifting columns are physically separate and distinct from each other, it is necessary to control each lifting column jointly and synchronously. In this regard, each lifting column 1 may comprise a radio communication device 51 operatively connected to the control unit 50 and configured to establish a wireless operating network between the various lifting columns. The wireless operating network may be a radio frequency network having a frequency between 2.4 GHZ and 2.5 GHZ, optionally substantially 2.4 GHz. The wireless operating network allows for controlling a height movement of the lifting column 2 of each, or at least a selected group, of lifting columns 1a, 1b, 1c by acting on a single column.

The lifting column 1 may further comprise a weight detector, not shown in the appended Figures, operatively connected to the control unit 50 and configured to output a weight signal representative of a weight weighing on the lifting column. The control unit 50 of the lifting column may be configured to receive the weight signal, and calculate, based on the weight signal, a numerical value representative of the weight weighing on the lifting column. The information of the weight weighing on the lift 2 of the lifting column 1 may be used during the lifting procedure to detect any inconsistencies in weight between the lifting columns engaged in lifting the vehicle.

In this regard, during the lifting procedure, the control unit 50 of each lifting column 1 may be configured to:
calculate this numerical value representative of the vehicle weight weighing on each lifting column;
calculate a difference of the numerical weight value from each lifting column; and
if this difference in weight exceeds a predefined threshold, stop the height movement of the lift.

Each lifting column may further comprise one or more power batteries 16 operatively connected to the motor or actuator of the lift 2 and configured to provide sufficient power to ensure lifting of the vehicle. The power battery 16 may also be electrically connected in power to the control unit 50, the wireless communication module 11 and the radio communication device 51 of the lifting column 1. Optionally, the proximity communication device 13 and/or the auxiliary switch 14 may be similarly powered by the power supply battery 16. The power supply battery 16 can be a rechargeable type.

In fact, the lifting column's power supply battery 16 may be configured as a single power source to power each of the lifting column's electrical and electronic components.

### Connection Procedure 200

The lifting column 1, and in particular each of the lifting columns 1a, 1b, 1c, 1d, 1e, may be wirelessly connected to the remote portable device 30. The wireless connection between the remote portable device 30 and the lifting columns 1 may allow, as described below with respect to the procedure of generating 300 a virtual network of lifting columns to synchronously control the height movement of the lifts of each lifting column. The connection procedure 200 described below describes the steps for establishing wireless communication between the wireless communication module 11 of a lifting column and the remote portable device 30.

The connection procedure initially involves switching on the lifting column by positioning 201 the main switch 10 in the power supply position.

Thus, the connection procedure 200 includes allowing the activation 202 of the activator 12: the activator 12 may emit an activation signal when activated. The activation 202 step of the activator 12 may comprise establishing wireless proximity communication when the remote portable device 30 is within maximum distance of the proximity communication device 13. Alternatively, the activation 202 step may comprise allowing an operator to move the auxiliary switch 14 to the activation position.

Following the activation 202 step, the connection procedure comprises a step of activating 203 the wireless communication module 11 in response to the emission of the activation signal of the activator 12. In other words, if the activator emits said activation signal, the wireless communication module 11 may be activated by the control unit 50. Alternatively, the activator 12 may be pre-positioned to directly activate the wireless communication module 11, thus without the aid of the control unit 50.

Following the step of activating 203, the wireless communication module 11, the connection procedure may comprise a step of establishing 204 wireless communication between the remote portable device 30 and the wireless communication module 11.

Subsequently, the connection procedure 200 may comprise a step of transmitting 205 the unique identification code of the lifting column 1 from lifting column 1 to the remote portable device 30 via wireless communication.

Finally, the connection procedure 200, following the step of transmitting 205 the unique identification code, may comprise a step of interrupting wireless communication between the remote portable device 30 and the wireless communication module 11 of the column, for example by deactivating the wireless communication module 11. In detail, the connection procedure 200 may comprise a step of deactivating the wireless communication module 11, subsequent to the activating 203 step, within a predefined time interval. The predefined time interval may be between 30 seconds and 10 minutes, optionally, between 30 seconds and 5 minutes. The time interval may be calculated from the activation step 203 of the wireless communication module 11.

It should be noted that, wherein the system 100 comprises two or a plurality of lifting columns, the connection procedure 200 may be performed for each lifting column of said lifting columns. In greater detail, in the case of a first and a second lifting column, the connection procedure 200 may comprise the following steps of:
allowing the activation 202 of said activator 12 of a first lifting column 1a, said activator emitting an activation signal when activated, optionally wherein the activation 202 step of the activator 12 comprises establishing said wireless proximity communication or allowing to move the auxiliary switch 14 to the activation position;
activating 203 the wireless communication module 11 of the first lifting column 1a in response to the emission of said activation signal of the activator 12 of the first lifting column 1a;
establishing 204 wireless communication between said remote portable device 30 and said wireless communication module 11 of the first lifting column 1a;
transmitting 205 a unique identification code of the first lifting column 1a from said first lifting column 1a to the remote portable device 30 via said wireless communication, said unique identification code being stored in an electronic memory 52 of said first lifting column 1a and being representative of an identity of said first lifting column 1a;
allowing the activation 202 of said activator 12 of a second lifting column 1b, said activator emitting an activation signal when activated, optionally wherein the activation 202 step of the activator 12 comprises establishing said wireless proximity communication or allowing to move the auxiliary switch 14 to the activation position;
activating 203 the wireless communication module 11 of the second lifting column 1b in response to the emission of said activation signal of the activator 12 of the second lifting column 1b;
establish 204 wireless communication between said remote portable device 30 and said wireless communication module 11 of said second lifting column 1b; and
transmitting 205 a unique identification code of the second lifting column 1b from said second lifting column 1b to the remote portable device 30 via said wireless communication, said unique identification code being stored in an electronic memory 52 of said second lifting column 1b and being representative of an identity of said second lifting column 1b.

### Procedure of Generating 300 a Virtual Network

The system 100 may be configured to allow an operator to move the lifting column 2 of each of the lifting columns 1a, 1b, 1c in height by operating the control panel 15 of an individual lifting column 1 in the group of lifting columns 1a, 1b, 1c. Alternatively, in accordance with a further embodiment, the system 100 may be configured to allow an operator to move the lift 2 of each of the lifting columns 1a, 1b, 1c in height by means of the remote portable device 30.

In this regard, the system is configured to perform a procedure of generating 300 a virtual network between lifting columns 1a, 1b, 1c, wherein the virtual network comprises the unique identification codes of each lifting column to define a group of lifting columns 1a, 1b, 1c.

The procedure of generating 300 a virtual network may comprise a first step of performing the previously described connection procedure 200 between a first lifting column 1a of said lifting columns and the remote portable device 30, and subsequently saving 301 the unique identification code of the first lifting column 1a in the remote portable device 30. Subsequent to the step of saving 301, the first step of the generating procedure 300 may comprise a step of disconnecting 302 the wireless communication between the wireless communication module 11 of the first lifting column 1a and the remote portable device 30.

The procedure of generating 300 the virtual network further comprises a second step, subsequent to the first step of performing the connection procedure 200 between a second lifting column 1b and the remote portable device 30, and subsequently saving 301 the unique identification code of the second lifting column 1a in the remote portable device 30. Following the step of saving 301, the second step of the generating procedure 300 may comprise a step of disconnecting 302 the wireless communication between the wireless communication module 11 of the second lifting column 1b and the remote portable device 30. At this point, the generating procedure 300 may define the virtual network as comprising the unique identification code of the first lifting column 1a and the second lifting column 1b.

The generating procedure 300 is described below, also explaining the steps in the connection procedure:
allowing the activation 202 of said activator 12 of a first lifting column 1a, said activator emitting an activation signal when activated, optionally wherein the activation 202 step of the activator 12 comprises establishing said wireless proximity communication or allowing to move the auxiliary switch 14 to the activation position;
activating 203 the wireless communication module 11 of the first lifting column 1a in response to the emission of said activation signal of the 12 of the first lifting column 1a;
establishing 204 wireless communication between said remote portable device 30 and said wireless communication module 11 of the first lifting column 1a;
transmitting 205 a unique identification code of said first lifting column 1a from said first lifting column 1a to said remote portable device 30 via said wireless communication, said unique identification code being stored in an electronic memory 52 of said first lifting column 1a and being representative of an identity of said first lifting column 1a;
saving 301 said unique identification code of the first column 1a in said remote portable device 30;
disconnecting 302 wireless communication between the wireless communication module 11 of the first lifting column 1a and the remote portable device 30;
allowing the activation 202 of said activator 12 of a second lifting column 1b, said activator emitting an activation signal when activated, optionally wherein the activation 202 step of the activator 12 comprises establishing said wireless proximity communication or allowing to move the auxiliary switch 14 to the activation position;
activating 203 the wireless communication module 11 of the second lifting column 1b in response to the emission of said activation signal of the activator 12 of the second lifting column 1b;
establishing 204 wireless communication between said remote portable device 30 and said wireless communication module 11 of said second lifting column 1b;
transmitting 205 a unique identification code of the second lifting column 1b from said second lifting column 1b to the remote portable device 30 via said wireless communication, said unique identification code being stored in an electronic memory 52 of said second lifting column 1b and being representative of an identity of said second lifting column 1b;
saving 301 said unique identification code of the second column 1b in said remote portable device 30;
disconnecting 302 the wireless communication between the wireless communication module 11 of the second lifting column 1b and the remote portable device 30; and
defining said virtual network comprising the unique identification code of the first lifting column 1a and the second lifting column 1b.

The generating procedure 300 may also be extended to further lifting columns, e.g., by defining a virtual network comprising six lifting columns as shown in FIG. 3. In such a case, the generating procedure 300 in respect of a third lifting column 1c is further described below:
allowing the activation 202 of said activator 12 of a third lifting column 1c, said activator emitting an activation signal when activated, optionally wherein the activation 202 step of the activator 12 comprises establishing said wireless proximity communication or allowing to move the auxiliary switch 14 to the activation position;
activating 203 the wireless communication module 11 of the third lifting column 1c in response to the emission of said activation signal of the activator 12 of the third lifting column 1c;
establishing 204 wireless communication between said remote portable device 30 and said wireless communication module 11 of the third lifting column 1c;
transmitting 205 a unique identification code of the third lifting column 1c from said third lifting column 1c to the remote portable device 30 via said wireless communication, said unique identification code being stored in an electronic memory 52 of said third lifting column 1c and being representative of an identity of said third lifting column 1c;
saving 301 said unique identification code of the third column 1c in said remote portable device 30;
disconnecting 302 wireless communication between the wireless communication module 11 of the third lifting column 1c and the remote portable device 30; and
defining said virtual network comprises the unique identification code of the first lifting column 1a, the second lifting column 1b and the third lifting column 1c.

The procedure of generating 300 the virtual network may further comprise, subsequent to the step of disconnecting the last lifting column, reconnecting 303 the remote portable device 30 to the wireless communication module 11 of the first lifting column 1a via the wireless connection, and then transmitting 304, via the wireless connection, from the remote portable device 30 to the control unit 50 of the first lifting column 1a said virtual network comprising the unique identification codes of the lifting columns 1.

Once the virtual network has been generated and the unique identification codes transmitted to a lifting column forming part of the virtual network, the radio communication device 51 of said lifting column 1 is configured to establish a wireless operating network between the lifting columns forming part of the virtual network. The wireless operating network may be a radio frequency network having a frequency between 2.4 GHZ and 2.5 GHZ, optionally substantially equal to 2.4 GHZ. The control unit 50 of the lifting column 1 is configured to control, via the wireless operating network, a height movement of each lifting column of the virtual network. In other words, the control unit 50 of the lifting column 1 is configured to command a height movement of the lifting column 2 of the first lifting column 1a, and simultaneously command, via the wireless operating network, a height movement of the lifting column 2 of each, or at least a selected group, of the lifting columns 1a, 1b, 1c forming part of the virtual network.

### Remote Portable Device 30

The term “remote portable device 30” refers to a device that can be moved independently and physically separated from the lifting columns 1 and is easily carried by an operator. For example, the remote portable device 30 may be a pocket device. In fact, the remote portable device 30 is operatively connectable to a lifting column 1 solely via a wireless connection. In a non-limiting embodiment of the present invention, the remote portable device 30 comprises a smartphone or tablet.

The remote portable device 30 may comprise a wireless communication module 31 configured to establish wireless communication with the wireless communication module 11 of the lifting column 1. The wireless communication module 31 of the remote portable device may be analogous to the wireless communication module 11 of the lifting column 1, so as to establish said wireless communication.

The remote portable device 30 may comprise a proximity communication device 32 configured to establish wireless proximity communication with the proximity communication device 13 of the activator 12 of the lifting column 1 when the proximity communication device 32 of the remote portable device 30 is within the maximum distance from the proximity communication device 13 of the lifting column 1.

The remote portable device 30 may comprise a graphical interface 33 comprising at least one screen 34, and a controller 35 operatively connected to the wireless communication module 31 and the graphical interface 33. The controller 35 of the remote portable device 30 may be configured to generate on the screen 34 a virtual schematic representation 36 of the group of lifting columns 1 forming part of the virtual network and/or of the wireless operating network. Each lifting column may be identified on the virtual schematic representation based on its respective unique identification code. The virtual schematic representation 36 may further show a schematic outline of the vehicle V, wherein the representation of each lifting column 1 on the screen 34 is positioned at a specific region of the schematic outline of the vehicle V. In particular, the representation of each lifting column 1 on the screen 34 may correspond to the actual position of the corresponding lifting column relative to the vehicle V.

The screen 34 of the remote portable device 30 may be a touchscreen.

Further, the controller 35 may be configured to allow an operator to manually move the virtual schematic representation of a lifting column between the group of lifting columns from a first region to a second region, distinct from the first region, of the schematic outline of the vehicle V to define a new configuration of the lifting columns around the vehicle V. For example, referring to FIG. 1, a column of the virtual schematic representation placed on the front axle of vehicle V may be reversed in position with a lifting column placed on the rear axle of the vehicle.

Wherein the configuration of the columns has been changed by the operator, the procedure of generating a virtual network may comprise connecting the remote portable device 30 to the wireless communication module 11 of a lifting column in the lifting column group, e.g., to the first column 1a, and transferring the new configuration to the lifting column.

The remote portable device 30 may comprise a battery configured to power the wireless communication module 31, the graphical user interface 33 and the controller 35. The battery may also be configured to power the proximity communication device 32. In particular, during the connection procedure 200 and specifically during the step of activating the activator 12, the control unit 35 of the remote portable device 30 may be configured to electrically power the proximity communication device 32 of the remote portable device 30.

### Lifting Process

The present invention is also directed to a process of lifting vehicles. The lifting process may be performed by means of the system 100 previously described, and in particular by using lifting columns previously described in detail. The lifting process may comprise the steps of the previously described connection procedure 200. The lifting process may further comprise the steps of the procedure of generating 300 a virtual network previously described.

Following the procedures of linking and generating a virtual network, the connection procedure involves the control from the remote portable device 30 or from a column of the synchronised movement of a plurality of lifts 2 to distance a vehicle from the ground.

1. A system for lifting vehicles comprising at least one lifting column,
said at least one lifting column comprising:
a lift configured to lift a vehicle;
a control unit operatively connected to said lift and configured to command a height movement of the lift;
a main switch switchable between:
a power supply position in which said main switch is configured to supply power to the control unit and
a stop position in which said main switch is configured to prevent the supply of power to the control unit; and
a wireless communication module configured to establish wireless communication with a remote portable device, wherein at least one column comprises an activator, distinct from said main switch, configured to activate said wireless communication module.

2. The system according to claim 1, wherein:
in a first operating condition of the lifting column, said main switch is in the power supply position and said activator keeps said wireless communication module deactivated;
in a second operating condition of said lifting column, said main switch is in the power supply position and said activator activates said wireless communication module to enable wireless communication with said remote portable device;
wherein the wireless communication module is configured to establish said wireless communication with the remote portable device only after:
(a) the activator has activated the wireless communication module; or
(b) the activator has sent an activation signal to the control unit, wherein the control unit is configured to activate the wireless communication module after receipt of the activation signal.

3. The system according to claim 1, wherein the activator comprises at least one of:
a proximity communication device configured to establish wireless proximity communication with said remote portable device when said remote portable device is within a maximum distance from the proximity communication device, wherein the maximum distance is less than 30 cm, wherein the proximity communication device is configured to command activation of said wireless communication module if said wireless proximity communication has been established; and
a controllable auxiliary switch manually switchable between a respective activation position and a respective deactivation position, wherein the auxiliary switch, in the activation position, is configured to command the activation of the wireless communication module, and wherein said auxiliary switch, in the deactivation position, is configured to command the deactivation of said wireless communication module.

4. The system according to claim 3, wherein the activator comprises the proximity communication device.

5. The system according to claim 4, wherein the proximity communication device is configured to transmit a connection code to said remote portable device via the wireless proximity communication;
wherein the wireless communication module and the remote portable device are configured to establish the wireless connection based on said connection code.

6. The system according to claim 3, wherein the control unit is configured to perform a wireless connection procedure between said wireless communication module of said at least one lifting column and said remote portable device;
wherein the connection procedure comprises the steps of:
activating the activator, said activator emitting an activation signal when activated, wherein the activating step of said activator comprises establishing the wireless proximity communication or moving the auxiliary switch to the activation position;
activating the wireless communication module in response to the activation signal of the activator;
establishing wireless communication between the remote portable device and the wireless communication module if the wireless communication module is activated; and
transmitting a unique identification code of the at least one lifting column from the at least one lifting column to the remote portable device via the wireless communication, wherein the unique identification code is stored in a memory of the lifting column and is representative of an identity of the at least one lifting column.

7. The system according to claim 6, comprises two or more lifting columns having different unique identification codes;
wherein the connection procedure is performed for each lifting column of said two or more lifting columns;
wherein the lifting columns are transportable independently of each other within a work area and positionable around said vehicle;
wherein the lifting columns are distinct and physically separated from each other; and
wherein each lifting column has a power supply battery configured to power at least the control unit, the lift, and the wireless communication module.

8. The system according to claim 7, configured to perform a procedure of generating a virtual network between said lifting columns;
wherein the virtual network comprising the unique identification codes of each lifting column to define a group of lifting columns;
wherein the procedure of generating a virtual network comprises the steps of:
performing the connection procedure between a first lifting column of the lifting columns and the remote portable device;
saving the unique identification code of the first lifting column in said remote portable device;
disconnecting the wireless communication between the wireless communication module of the first lifting column and the remote portable device;
performing the connection procedure between a second lifting column of the lifting columns and the remote portable device;
saving the unique identification code of the second column in said remote portable device; and
disconnecting the wireless communication between the wireless communication module of the second lifting column and the remote portable device; and
wherein the procedure of generating a virtual network comprises a step of defining said virtual network as comprising the unique identification code of the first lifting column and the second lifting column.

9. The system according to claim 8, wherein the procedure of generating a virtual network, following the step of disconnecting from the second lifting column, comprises the steps of:
reconnecting the remote portable device to the wireless communication module of the first lifting column via the wireless connection; and
transmitting, via said wireless connection, from the remote portable device to the control unit of the first lifting column, wherein the virtual network comprises the unique identification codes of the lifting columns.

10. The system according to claim 8,
wherein each lifting column of the virtual network comprises a radio communication device operatively connected to the control unit and configured to establish a wireless operating network between said lifting columns of said virtual network based on the unique identification codes of said virtual network;
wherein at least the control unit of the first lifting column of said lifting columns is configured to:
command a height movement of the lift of said first lifting column, and simultaneously
command, via said wireless operating network, a height movement of the lift of each, or at least a selected group, of said lifting columns forming part of the virtual network.

11. The system according to claim 1,
wherein the activator comprises a proximity communication device configured to establish wireless proximity communication with said remote portable device when said remote portable device is within a maximum distance from the proximity communication device, wherein the maximum distance is less than 30 cm;
wherein the proximity communication device is configured to command activation of said wireless communication module if said wireless proximity communication has been established; and
wherein the wireless communication between the wireless communication module and the remote portable device extends spatially to define a coverage greater in extent than an extent of a coverage defined by the wireless proximity communication.

12. The system according to claim 11, wherein the coverage extent defined by the wireless communication is greater by at least a factor of between 5 and 8 times than the coverage extent defined by the wireless proximity communication.

13. The system according to claim 1,
wherein the activator comprises a proximity communication device configured to establish wireless proximity communication with said remote portable device when said remote portable device is within a maximum distance from the proximity communication device, wherein the maximum distance is less than 30 cm;
wherein the proximity communication device is configured to command activation of said wireless communication module if said wireless proximity communication has been established; and
wherein the proximity communication device uses an NFC-type communication protocol to establish said wireless proximity communication.

14. The system according to claim 1, wherein said wireless communication module comprises a Bluetooth module configured to establish said wireless communication.

15. The system according to claim 1,
wherein the activator comprises a proximity communication device configured to establish wireless proximity communication with said remote portable device when said remote portable device is within a maximum distance from the proximity communication device, wherein the maximum distance is less than 30 cm,
wherein the proximity communication device is configured to command activation of said wireless communication module if said wireless proximity communication has been established; and
wherein the remote portable device comprises at least:
a wireless communication module configured to establish such wireless communication with the wireless communication module of at least one lifting column;
a proximity communication device configured to establish wireless proximity communication with said proximity communication device of the activator of the at least one lifting column when said proximity communication device of the remote portable device is within said maximum distance from said proximity communication device) of said at least one lifting column;
a graphic interface comprises at least one screen;
a controller operatively connected to said wireless communication module and said graphic interface; and
a battery configured to power said wireless communication module, said graphic interface and said controller.

16. The system according to claim 15,
wherein the system is configured to perform a procedure of generating a virtual network between said lifting columns,
wherein the virtual network comprising the unique identification codes of each lifting column to define a group of lifting columns, and
wherein the controller of the remote portable device is configured to generate on the screen a virtual schematic representation of the group of lifting columns forming part of the wireless operating network.

17. The system according to claim 16,
wherein each lifting column is identified on the virtual schematic representation based on its unique identification code; and
wherein the controller of the remote portable device is configured to update the virtual schematic representation shown on the screen according to the lifting columns forming part of the virtual network.

18. The system according to claim 17,
wherein the virtual schematic representation comprises a schematic outline of the vehicle, wherein the representation of each lifting column on said screen is positioned at a specific region of said schematic outline of the vehicle;
wherein the controller is configured to allow an operator to manually move the virtual schematic representation of a lifting column of said group of lifting columns from a first region to a second region, distinct from the first region, of the vehicle's schematic outline to define a new configuration of lifting columns around the vehicle;
wherein the procedure of generating a virtual network comprises the steps of:
connecting said remote portable device to the wireless communication module of a lifting column of said lifting column group; and
transferring said new configuration to said lifting column.
